(19) United States
(12) Patent Application Publication
(10) Pub. No.: US 2012/0092973 A1
(43) Pub. Date: Apr. 19, 2012

(54) LIGHT SPOT FORMING ELEMENT, OPTICAL RECORDING HEAD, AND OPTICAL RECORDING DEVICE

(76) Inventors: Masahiro Imada, Osaka (JP); Koujirou Sekine, Osaka (JP); Hiroshi Hatano, Osaka (JP)

(21) Appl. No.: 13/378,298

(22) PCT Filed: Feb. 10, 2010
(86) PCT No.: PCT/JP2010/051948

§ 371 Date: Dec. 14, 2011

(30) Foreign Application Priority Data
Jun. 19, 2009 (JP) 2009-146260

(51) Int. Cl. F21V 8/00; G11B 13/04; G11B 15/64

(52) U.S. Cl. 369/13.32; 362/259; 369/300; G9B/15.083; G9B/13.003

(57) ABSTRACT

Disclosed is a light spot forming element which is capable of forming a minute stabilized light spot efficiently and is easy to handle. For this purpose, there is provided a light spot forming element wherein a laser oscillation unit which has a periodic refractive index distribution and is employed as a laser resonator, and a focusing unit that receives the light emitted by this laser oscillation unit and forms a light spot by focusing this received light are formed on the same substrate.

### TECHNICAL FIELD

The present invention relates to a light spot forming element, an optical recording head, and an optical recording device.

### BACKGROUND

Over recent years, with an increase in density of information recording media, recording methods of various types are being proposed and of these, there is a heat assisted magnetic recording method. Such a heat assisted magnetic recording method is a method, in which local heating is carried out during recording for magnetic softening and in the state where coercivity has been decreased, recording is carried out; and thereafter heating is terminated, followed by natural cooling to ensure the stability of recorded magnetic bits.

In the heat assisted magnetic recording method, it is desirable to instantaneously heat a recording medium during recording, and also a heating mechanism and the recording medium are not allowed to be in contact with each other. Therefor, heating is commonly carried out by use of light absorption and a method employing light for heating is referred to as an optically assisted type. When high-density recording is carried out using such an optically assisted type, a minute light spot having a size of at most the wavelength of used light is required.

The following is disclosed as an optical recording head employing a minute light spot. The optical recording head described in Patent Document 1 is provided with a writing magnetic pole and a waveguide having a core layer and a clad layer adjacent to this writing magnetic pole. The core layer is provided with a diffraction grating (referred to also as a grating coupler) to introduce light into the core layer. When laser light is irradiated to this grating coupler, the laser light is coupled with the core layer. Light having been coupled with the core layer is converged at a focus located in the vicinity of the tip portion of the core layer and then a recording medium is heated by light emitted from the tip portion for writing using the writing magnetic pole. An element having a waveguide with such a light collecting function is referred to as a waveguide-type solid immersion mirror (PSIM: Planer Solid Immersion Mirror), and the PSIM described in Patent Document 1 is provided with a diffraction grating. When the ratio of the amount of light collected at a PISM to the amount of light entering this diffraction grating (the usage efficiency of light) is taken into account, in the incident angle of light to the diffraction grating at the wavelength of incident light, there exists an appropriate angle.

Further, Patent Document 2 discloses a semiconductor laser in which as a method to form a minute light spot, in the end surface of the resonator of the semiconductor laser, a metal light shielding body having a coaxial opening is arranged.

### PRIOR ART DOCUMENTS

### Patent Documents

Patent Document 1: U.S. Pat. No. 6,944,112 specification

Patent Document 2: Unexamined Japanese Patent Application Publication No. 2001-244564

### BRIEF DESCRIPTION OF THE INVENTION

### Problems to be Solved by the Invention

However, Patent Document 1 merely describes that light from a light source arranged separately from a PSIM is irradiated simply obliquely to a diffraction grating, and does not describe any specific method to introduce light from the light source into the diffraction grating with no variation of the incident angle. Further, the introduction efficiency of laser light into the PSIM is changed due to the wavelength variation of light from the light source. Thereby, the relative locational shift of the PSIM and the light source and wavelength variation occur, resulting in no formation of a stable light spot.

In the semiconductor laser described in Patent Document 2, in a resonator, a coaxial opening is formed and thereby no relative locational shift between the both is generated. However, light generated from the resonator is not collected and then directly irradiated to the coaxial opening, whereby light which is not irradiated to the coaxial opening is not used, resulting in the decrease of the usage efficiency of light. Further, to increase the intensity (optical intensity) of laser light generated from the coaxial opening, the intensity of laser light itself emitted from the resonator needs to increase. To realize necessary intensity, a semiconductor laser having large power consumption and large outer appearance is required.

In view of the above problems, the present invention was completed. An object thereof is to provide a light spot forming element, easy to handle, to efficiently form a stable minute light spot, an optical recording head using this element, and an optical recording device.

### Means to Solve the Problems

The above problems are solved by the following constitution:

1. A light spot forming element comprising: a laser oscillation section having a periodic refractive index distribution used as a laser resonator; and a light collection section for introducing light emitted from the laser oscillation section and for forming a light spot by collecting the introduced light, wherein the laser oscillation section and the light collection section are formed on a single substrate.

2. The light spot forming element described in item 1, further comprising a plasmon antenna in a vicinity of a location where the light spot is formed to generate plasmon by irradiation of collected light and amplify the plasmon to be taken out as near-field light resulting in the light spot.

3. The light spot forming element described in item 1 or 2, wherein the light collection section is a light waveguide having a core layer provided with 2 side surfaces defining substantially parabolic outlines and a tip portion having a light ejection surface, from which light is ejected, defined by end portions of the 2 side surfaces in a vicinity of a location where the light spot is formed; and light emitted from the laser oscillation section is introduced from a light introduction opening defined by end portions of the 2 side surfaces on an opposite side to the tip portion.

4. The light spot forming element, described in item 1 or 2, wherein the light collection section comprises: a light waveguide having a core arranged along a light path from an end portion of the laser oscillation section to a location where the light spot is formed in which one end is located away from the end portion of the laser oscillation section, the other end is located at a location where the light spot is formed, and a cross-section area of the one end is smaller than a cross-section area of the other end; and a clad to bury a space from the end portion of the laser oscillation section to the location where the light spot is formed so as to wrap the core, and a refractive index of a material of the clad is smaller than a refractive index of a material of the core.

5. The light spot forming element, described in any one of items 1-4, wherein the periodic refractive index distribution has a structure where refractive index is periodically changed in directions at right angles to each other.

6. An optical recording head to carry out information recording on a recording medium using light, comprising: a slider which moves relatively to the recording medium; and the light spot forming element of any one of items 1-5.

7. An optical recording device comprising: the optical recording head described in claim 6 provided with a magnetic recording section; and the recording medium on which information is recorded by the optical recording head.

### Effects of the Invention

According to the light spot forming element of the present invention, a laser oscillation section to oscillate only light having specific wavelength and a light collection section to collect light having been emitted from the laser oscillation section are provided on a single substrate. Thereby, the laser oscillation section and the light collection section can be integrally handled, and even during operation, the locational relationship between the laser oscillation section and the light collection section is not shifted, whereby light having been emitted from the laser oscillation section is stably collected with no wavelength variation.

Therefore, a light spot forming element, easy to handle, to efficiently form a stable minute light spot, an optical recording head using this element, and an optical recording device can be provided.

### BRIEF DESCRIPTION OF THE DRAWINGS

FIG. 1 is a view showing an example of the schematic constitution of an optical recording device in which an optically assisted magnetic recording head is mounted;

FIG. 2 is a view schematically showing an optical recording head and its periphery using a cross-section;

FIG. 3 is a view showing one example of a light spot forming element in which FIG. 3A is a top view and FIG. 3B is a cross-sectional view;

FIG. 4 is a view showing one example of a light spot forming element in which FIG. 4A is a top view and FIG. 4B is a cross-sectional view;

FIG. 5 is a view showing an example of a plasmon antenna;

FIG. 6 is a view showing a production process of a light spot forming element;

FIG. 7 is a view showing a production process of a light spot forming element;

FIG. 8 is a view showing a production process of a light spot forming element;

FIG. 9 is a view showing a production process of a light spot forming element;

FIG. 10 is a view showing a production process of a light spot forming element; and

FIG. 11 is a view showing a production process of a light spot forming element.

### PREFERRED EMBODIMENTS OF THE INVENTION

The present invention relates to a light spot forming element to irradiate a minute region with laser light. This light spot forming element is usable for, for example, an optical recording head to carry out recording on a magnetooptical recording medium or an optical recording medium.

Optically assisted magnetic recoding heads in embodiments of the present invention and optically assisted recording devices provided therewith will now be described, but the present invention is not limited to the embodiments. Incidentally, in each of the embodiments, mutually the same portions and equivalent portions are assigned with the same symbols to appropriately omit overlapping description.

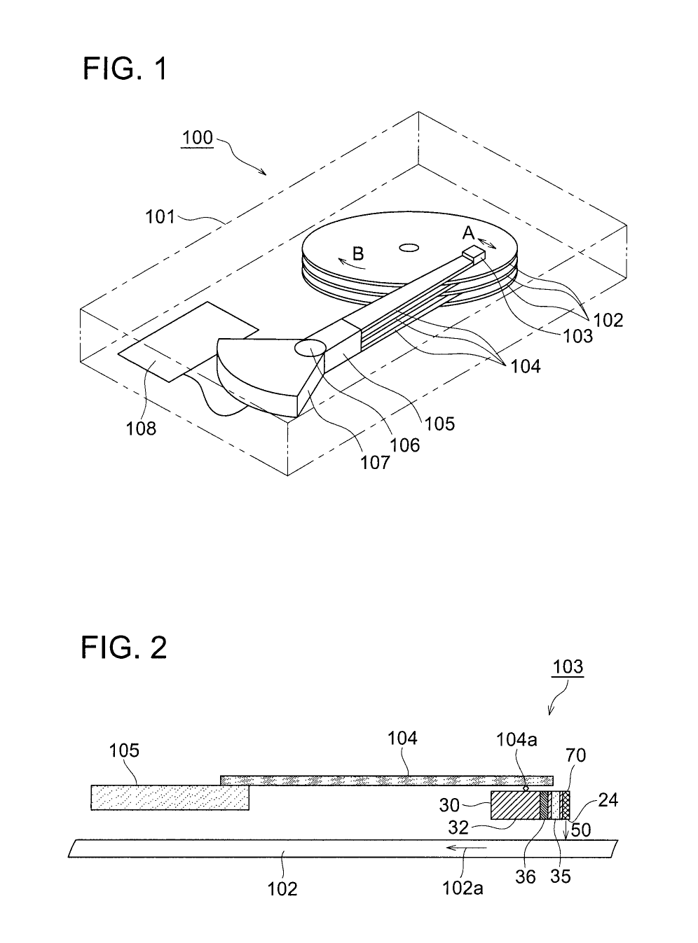

FIG. 1 shows a schematic constitution of an optical recording device (for example, a hard disk device) mounted with an optically assisted magnetic recording head of the embodiments of the present invention. This optical recording device 100 is provided with following (1)-(6) in a housing 101.

(1) Recording disk (recording medium) 102

(2) Suspension 104 supported by an arm 105 provided in the arrow A direction (tracking direction) rotatably around a supporting shaft 106 as the support point

(3) Tracking actuator 107, attached to the arm 105, to rotationally drive the arm 105

(4) Optically assisted magnetic recording head (hereinafter, referred to as an optical recording head 103) containing the suspension 104 and a slider 30 attached to the tip portion thereof via a joint member 104a

(5) Motor (not shown) to rotate the disk 102 in the arrow B direction

(6) Control section 108 to carry out control for optical recording on the disk 102 using the tracking actuator 107, the motor, and the optical recording head 103 to generate light irradiated based on writing information for recording on the disk 102 and a magnetic field

In the optical recording head 100, a constitution is made in which the slider 30 can relatively move above the disk 102 while floating.

FIG. 2 schematically shows the constitution of an optical recording head 103 according to the present invention using a cross-section. The optical recording head 103 is an optical recording head employing light for information recording on a disk 102 and incorporates a light spot forming element 70 according to the present invention, a magnetic recording section 35, and a magnetic information regeneration section 36. Incidentally, in the light spot forming element 70 of FIG. 2, when specific examples are described below, other symbols are added to the symbol 70 to be shown as light spot forming elements 70A, 70A-1, 70B, and 70B-1.

The slider 30 moves relatively, while floating, to the disk 102, a magnetic recording medium. For the material of the slider 30, a hard material exhibiting large abrasion resistance is preferably used. For example, a ceramic material containing Al₂O₃, AlTiC, zirconia, or TiN may be used. Further, for abrasion prevention treatment, to enhance abrasion resistance, the surface of the disk 102 side of the slider 30 may be subjected to surface treatment such as DLC (Diamond Like Carbon) coating.

Further, the surface of the slider 30 opposite to the disk 102 has an air bearing surface 32 (referred to also as an ABS (Air Bearing Surface)) to enhance floating characteristics.

It is necessary to stabilize the floating of the slider 30 in the state of being close to the disk 102 and to appropriately apply pressure to suppress the floating power of the slider 30. Therefor, the suspension 104 holding the slider 30 functions to track the slider 30 and also to appropriately apply pressure to suppress the floating power of the slider 30.

In the slider 30, on the side of the inflow side of the disk 102, the light spot forming element 70 is provided almost vertically to the recording surface of the disk 102.

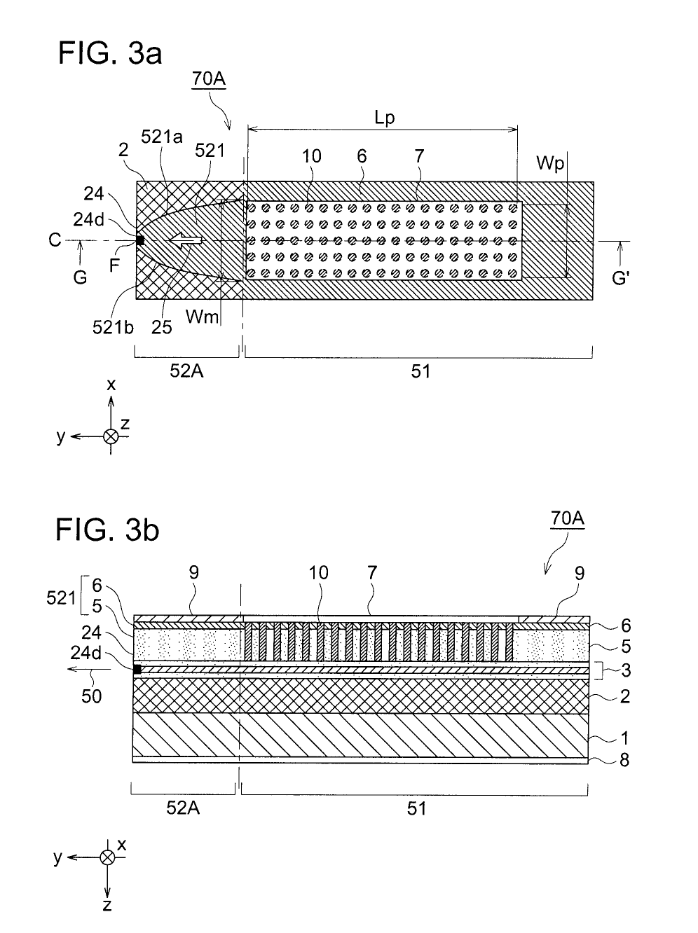

The light spot forming element 70 is provided with a laser oscillation section to generate laser light and a light collection section to collect light emitted from the laser oscillation section to be introduced into the lower end surface 24. The laser oscillation section will be described as a semiconductor laser, being able to be an organic dye laser other than the semiconductor laser. In the lower end surface 24 of the light collection section, a plasmon antenna 24d (refer to FIG. 3) to generate near-field light is provided as a preferred embodiment. Incidentally, in FIG. 2, a plasmon antenna 24d, to be described later, provided in a location where light of the lower end surface 24 is ejected or in its vicinity is omitted.

When emitted light from the lower end surface 24 of the light spot forming element 70 is irradiated to a disk 102 as a minute light spot being near-field light generated by the plasmon antenna 24d, then the temperature of an irradiated portion of the disk 102 is temporarily increased to decrease the coercivity of the disk 102. In the portion having the thus-decreased coercivity, magnetic information is written using the magnetic recording section 35. Further, the magnetic information regeneration section 36 to read out magnetically recorded information having been written in the disk 102 is provided at a position immediately after the magnetic recording section 35 in the moving direction (the arrow 102a direction) of the rotating disk 102 but may be provided at a position immediately before the light spot forming element 70.

The light spot forming element 70 will now be described.

FIG. 3 schematically shows, as a specific example of the light spot forming element 70, the schematic constitution of a light spot forming element 70A having a semiconductor laser oscillation section (hereinafter referred to as an oscillation section) 51 and a light collection section 52A. FIG. 3A is a top view of the light spot forming element 70A and FIG. 3B is a G-G′ line arrow cross-sectional view of FIG. 3A.

Herein, in FIG. 3B, a protective film 9 to cover the upper surface side is shown but in FIG. 3A, this protective film 9 is omitted.

The oscillation section 51 will now be described. The oscillation section 51 is provided with a substrate 1, a second clad layer 2 formed on one main surface of the substrate 1, an active layer 3 formed on the second clad layer 2, a semiconductor laminated portion having a first clad layer 5 and a contact layer 6 formed on the active layer 3, a first electrode 7 formed on the contact layer 6, and a second electrode 8 formed on the other main surface opposite to the one main surface in the substrate 1. Further, the oscillation section 51 has a photonic crystal structure of a preferred embodiment as periodic refractive index distribution used as a laser resonator.

The substrate 1 is, for example, an n-type GaAs substrate (refractive index: 3.524). The second clad layer 2 is, for example, an n-type semiconductor layer in which an electron is a carrier, being formed of; for example, n-type Al_{0.4}Ga_{0.6}As (refractive index: 3.306). The first clad layer 5 is, for example, a p-type semiconductor layer in which a hole (positive hole) is a carrier, being formed of, for example, p-type AlₓGa₍₁₋ₓ₎As (x is commonly 0.0-0.6). The contact layer 6 is, for example, a p-type semiconductor layer in which a hole (positive hole) is a carrier, being formed of, for example, p+-type GaAs.

The conductivity type of each semiconductor layer in the first clad layer 5 and the second clad layer 2 is not limited to the above one. For example, as in a buried tunnel junction (BTJ) type, a structure is employable in which in the upper layer (the first clad layer 5 side) of the active layer 3, p-type and n-type semiconductor layers differing in conductivity type are provided.

As described above, the active layer 3 is sandwiched by a second clad layer 2 and a semiconductor layer incorporating a contact layer 6 and a first clad layer 5 to generate (emit) light via carrier injection. For the active layer 3, any appropriate well-known common material and structure are employable, and the material and the structure are selected so as to emit an appropriate wavelength based on the intended usage. The active layer 3 is allowed to have a distorted quantum-well structure constituted of, for example, a 3-period InGaAs well layer, GaAs barrier layer, and separate confinement heterostructure (SCH) layer.

The first clad layer 5 and the second clad layer 2 are formed of a material having refractive index smaller than that of the active layer 3 (for example, 3.54 in the case of the distorted quantum-well structure) and also provided with the function to confine light in the active layer 3. Further, the refractive index of the first clad layer 5 is preferably larger than that of the second clad layer 2. Even when a photonic crystal structure is formed by increasing the refractive index of the first clad layer 5, the average refractive index of the first clad layer 5 is not excessively decreased. Thereby, the decrease of the ratio of light distributing in a layer where a photonic crystal structure is formed is prevented, whereby the decrease of the ratio of optical coupling with the photonic crystal structure (referred to as the optical coupling coefficient) can be prevented.

The active layer 3 is sandwiched by the first clad layer 5 and the second clad layer 2 to form a double hetero-junction and then carriers are confined, and thereby carriers contributing to light emission are concentrated in the active layer 3. The contact layer 6 is placed between the first electrode 7 and the first clad layer 5 to electrically connect them. Between the first clad layer 5 and the active layer 3, another layer such as a carrier stop layer (for example, Al_{0.6}Ga_{0.4}As, refractive index: 3.195) functioning as a potential barrier against electrons moving toward the first clad layer 5 from the active layer 3 via carrier overflow may be mediated.

The photonic crystal structure is preferably two-dimensionally provided with a refractive index period. In the case of a striped groove shape in which, for example, concave portions extend in the x direction as a periodic structure, when a refractive index period having a period in they direction is one-dimensionally provided, the wavelength is stabilized compared with in a Fabry-Perot-type laser. However, when the width of the semiconductor laser oscillation section 51 is intended to increase to fit into the width Wm of the light introduction opening of the light collection section 52A, to be described later, the optical intensity distribution and the oscillation wavelength of the transverse (width) direction become multimodal. Therefor, the periodic structure preferably has refractive index periods two-dimensionally in the x and y directions. The oscillation section 51 is allowed to have a two-dimensional photonic crystal structure extending in the x and y directions, and thereby wide-ranging, single-mode, and coherent laser light, able to efficiently introduce light into the light collection section 52A, can be oscillated.

Specifically, as shown in FIG. 3A and FIG. 3B, a formation is made in which a material having refractive index differing from those of materials to form the first clad layer 5 and the contact layer 6 is arranged, as grid points, in 2 directions of x and y at right angles to each other with a predetermined period (grid distance or grid constant).

In the present embodiments, the grid points are square grids of a preferred embodiment constituted of columnar concave portions 10 formed in the first clad layer 5 and the contact layer 6 with no limitation thereto. Rectangular grids are employable. The shape of the concave portion 10 is a columnar one with no limitation to this shape, being possibly a quadrangular prism, a triangular prism, or a circular cone.

The interior of the depression of a concave portion 10 is filled with a material having refractive index differing from that of a material forming the first clad layer 5. For example, the material of the first clad layer 5 is allowed to be AlₓGa₍₁₋ₓ₎As (commonly, x=0.0-0.6) (refractive index: 3.195 (x=0.6)-3.524 (x=0.0); wavelength: 980 nm), and then SiO₂ (refractive index: 1.5) or SiN (refractive index: 2.0) is cited as a material to fill the concave portion 10. The interior of the depression of the concave portion 10 may be filled with air from the viewpoint of refractive index. However, the above SiO₂ (refractive index: 1.5) or SiN (refractive index: 2.0) is preferably filled, since the first electrode 7 can be flatly provided and also oxidation of the interior of the concave portion 10 can be prevented.

When formed by etching from the contact layer 6 side, concave portions 10 are formed at least on the surface of the side in contact with the first electrode 7, depending though on the production method. This photonic crystal structure selects the wavelength of light laser-oscillated in the active layer 3. As shown in FIG. 3A, when viewed from the contact layer 6 side, the region where concave portions 10 are formed has a reed shape having length Lp and width Wp. Of light having leaked from the active layer 6 and then having entered the two-dimensional photonic crystal structure, light having wavelength coinciding with the periodic distance of the concave portions 10 in this reed shape is resonated.

As the bottom surface of the concave portions 10 is close to the active layer 3, optical coupling efficiency with respect to the two-dimensional photonic crystal structure can increase. The concave portions 10 may reach the contact layer 6 and the first clad layer 5, but reaching the active layer 3 is not preferable. When the concave portions 10 reach the active layer 3, namely, the photonic crystal structure and the active layer 3 become close to each other, during etching for concave portion 10 formation, the active layer 3 may be damaged.

In the oscillation section 51, a voltage is applied between the first electrode 7 covering the concave portions 10 and the second electrode 8, whereby carriers are injected into the active layer 3 and then at a voltage of at least a predetermined value, light is emitted from the active layer 3. Light having been generated in the active layer 3 leaks to the photonic crystal structure for laser oscillation.

When such a photonic crystal structure is employed, both end surfaces need not to be reflection surfaces as in a FP-type laser, and thereby at one end of the oscillation section 51, a light collection section 52A can be provided. Further, oscillation wavelength is stabilized with the photonic crystal structure. Then, stabilization of the oscillation wavelength causes no concern such that wavelength variation resulting from a mode hop phenomenon in a FP-type laser varies light collection characteristics, which then produces an adverse effect on a light spot to be formed.

In a photonic crystal structure region shown with length Lp and width Wp in FIG. 3A, the length Lp is preferably at least the length where laser oscillation and oscillation wavelength are stabilized. Further, the width Wp is preferably determined based on the width Wm of the light introduction opening able to be conceptually determined by the clearance of 2 sides in which the outer circumferential outline possessed by a light collection section 52A, to be described later, is parabolic.

The light introduction opening is an entrance in which laser light emitted from the oscillation section 51 is received by the light collection section 52A. Light having entered from the light introduction opening of the light collection section 52A with about width Wp is collected by the light collection function of the light collection section 52A to form a light spot. Preferable is width Wp such that light emitted from the oscillation section 51 can be introduced from the introduction opening of the light collection section 52A with no leakage and then a light spot of desired optical density can be formed.

The light collection section 52A will now be described. As shown in FIGS. 3A and 3B, in the light collection section 52A, on a substrate 1 in which an oscillation section 51 is formed, a core section 521 and a protective film 9 functioning as a clad is provided. A second clad layer 2, a core section 521, and a protective film 9 constitute a light waveguide. The core section 521 has a semiconductor laminated portion in the thickness direction in the same manner as in the oscillation section 51, having a shape such that in the semiconductor laminated portion, the outer side portions in the side portions of the active layer 3, the first clad layer 5, and the contact layer 6 are removed so as for the outer circumferential outline of the sides 521a and 521b to become parabolic.

In the light collection section 52A, the upper surfaces of the second clad layer 2 of the outsides of the sides 521a and 521b, the parabolic sides 521a and 521b, and the contact layer 6 of the first electrode 7 side are covered by a protective film 9 such as SiO₂ having refractive index smaller than that of the core section 521. This protective film 9 has a smaller refractive index than the core section 521 and thereby functions as a clad, constituting a waveguide together with the second clad layer 2 and the core section 521. Laser light, traveling in the +y direction, having been oscillated with about width Wp by the photonic crystal structure of the oscillation section 51 is confined in the core section 521 interior to travel in the allow 25 direction.

The sides 521a and 521b of the core section 521 are formed so that a practically parabolic outline reflecting toward a focus F is constituted so as for light traveling in the +y direction (the arrow 25 direction) with about width Wp to be collected at the focus F. In FIG. 3, the center axis in which the outline is bilaterally symmetrical in the parabola is shown by axis C (a line passing through the focus F vertically to the directrix (not shown)) and the focus of the parabola is shown as the focus F. The thicknesses (the z direction) of the sides 521a and 521b are extremely small, for example, about 1 μm, and thereby practically specify the outline of the core section 521.

In the sides 521a and 521b of the core section 521, 2 end portions of the oscillation section 51 are light incident sides and specify the light introduction opening of conceptual width Wm to receive laser light of about width Wp from the oscillation section 51. Further, 2 end portions of the light ejection opening side located on the opposite side to the light introduction opening are located in the lower end surface 24 having a flat surface shape such that the tip of the parabola is cut in the nearly vertical direction to axis C, specifying the light ejection surface.

Light 50 emitted from the focus F is rapidly diverged. Therefore, the shape of the lower end surface 24 is preferably allowed to be flat, since the focus F can be arranged closer to the disk 102 and then light having been collected enters the disk 102 prior to large divergence. The focus F may be formed in the lower end surface 24 with no limitation thereto and the focus F may be formed on the outside of the lower end surface 24. Incidentally, in the present example, the lower end surface 24 is allowed to be flat but needs not always to be flat.

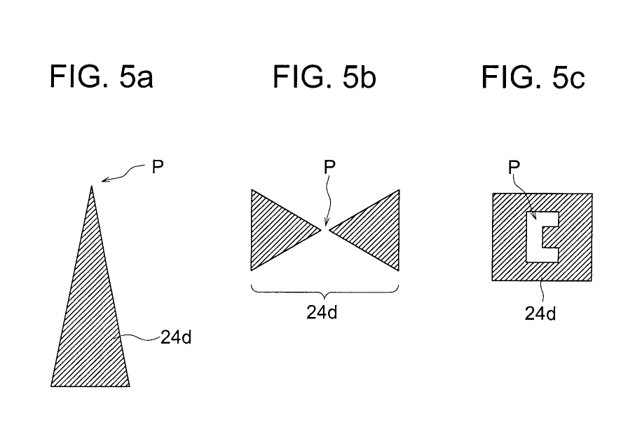

At the focus F of the core section 521 or in its vicinity, a plasmon antenna 24d for generation of near-field light is arranged in which plasmon is generated by irradiation light and amplified to be taken out as near-field light. Specific examples of the plasmon antenna 24d are shown in FIG. 5.

In FIG. 5, FIG. 5A shows a plasmon antenna 24d formed of a triangular flat metal thin film and FIG. 12B shows a plasmon antenna 24d formed of a bow-tie-type flat metal thin film in which each of them is formed with an antenna having a peak P featuring a curvature radius of at most 20 nm. Further, FIG. 5C shows a plasmon antenna 24d formed of a flat metal thin film with an opening having an antenna of a peak P featuring a curvature radius of at most 20 nm. The material for the metal thin film of any of the plasmon antennas 24d includes aluminum, gold, and silver.

When light acts on any of the plasmon antennas 24d, in the vicinity of the peak P, near-field light is generated, and thereby recording can be carried out using light of extremely small spot size. Namely, at the focus F of the core section 521 or in its vicinity, a plasmon antenna 24d is provided to generate a localized plasmon, and thereby the size of a light spot having been formed at the focus can be further reduced, which is advantageous in high-density recording. Herein, the peak P of the plasmon antenna 24d is preferably located at the focus F.

Incidentally, the location of the z direction (the thickness direction) where a plasmon antenna 24d is arranged in the lower end surface 24 is preferably determined based on a location where light intensity is largest in a light intensity distribution in the case where laser light emitted from the semiconductor laser oscillation section 51 is wave-guided in the light collection section 52A to travel in the +y direction and then reach the lower end surface 24.

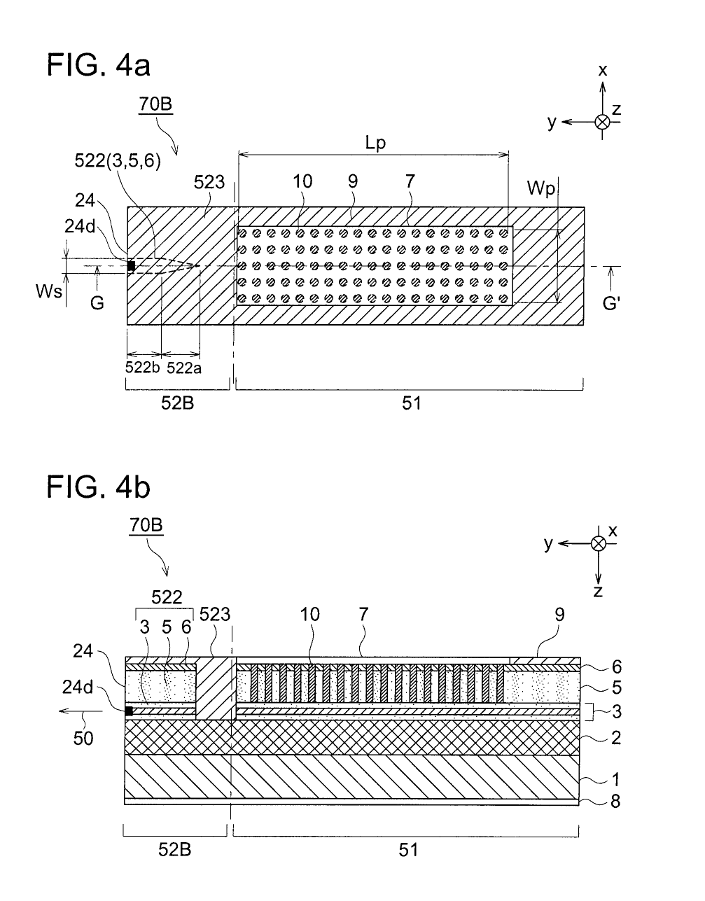

As another example of the light collection method of the light collection section 52A shown in FIG. 3, a light spot forming element 70B provided with a light collection section 52B is shown in FIG. 4. In FIG. 4, the oscillation section 51 is the same as for the light spot forming element 70A having been shown and described in FIG. 3 and therefore description thereof will be omitted. FIG. 4A is a top view of the light spot forming element 70B and FIG. 4B is a G-G′ arrow cross-sectional view of FIG. 4A.

As shown in FIGS. 4A and 4B, the light collection section 52B is provided with a core section 522 and a clad section 523 on a substrate 1 in which an oscillation section 51 is formed. The core section 522 has an island shape extending in the y direction in which in the portion of the active layer 3, the first clad layer 5, and the contact layer 6 cut off from the oscillation section 51, the oscillation section 51 side is sharp-pointed and the opposite side is flat in the same face as the lower end surface 24. The clad section 523 is a space ranging from the lower end surface 24 to the oscillation section 51, being a portion filled with a material having refractive index smaller than the core section 522 to cover the core section 522. The second clad layer 2, the core section 522, and the clad section 523 constitute a light waveguide.

In the light collection section 52B, the +y direction is the light propagation direction, and the portion of the light incident side of the core section 522 is provided with a clad section 523 (for example, SiO₂) having refractive index lower than the core section 522. As laser light from the semiconductor laser oscillation section 51 enters the clad section 523 and the thus-entered light travels in the light propagation direction, the light gradually converges to the core section 522 having larger refractive index. Thereby, the light spot size at the initiation of entering the clad section 523 is reduced to reach the lower end surface 24 being the end surface of the core section 522. Especially, as laser light of about width Wp emitted from the oscillation section 51 travels to the lower end surface 24, the light is optically coupled so as to be gradually collected in the core section 522, resulting in a small size of about the width of the core section 522.

As shown in FIG. 4A, the core section 522 is preferably provided with a peaked portion 522a gradually narrowing toward the light incident side (the oscillation section 51 side) from the light ejection (the lower end surface 24) side and a columnar portion 522b having an unchanged cross-sectional shape between the end surface of the lower end surface 24 side and the peaked portion 522a. The smooth change of the core width of the peaked portion 522a makes it possible to efficiently convert mode field diameter. Namely, a light spot of about width Wp ejected from the oscillation section 51 is converted, with reduction of the width, into a light spot of about the width of the core section 522. During this conversion, the smooth change of the core width Ws (the width of the x direction of the core section 522) of the peaked portion 522a makes it possible to efficiently carry out light spot conversion.

Further, when a columnar portion 522b having unchanged core width Ws is provided, the waveguide mode is stabilized, resulting in loss prevention. The distance from the tip position of the peaked portion 522a to the semiconductor laser oscillation section 51 is preferably determined based on the width Wp. Appropriate setting makes it possible to allow laser light wave-guided in the light collection section 52B to be in the single mode.

Herein, between the core section 522 and the clad section 523, a subcore section having refractive index between the refractive indexes of the core section 522 and the clad section 523 may be provided. When such a subcore section is provided, the allowance range of the locational error of the core section 522 and the oscillation section 51 can be increased.

Incidentally, the location of the z direction where a plasmon antenna 24d is arranged in the lower end surface 24 is determined based on the location where light intensity is largest in a light intensity distribution in the case where laser light emitted from the semiconductor laser oscillation section 51 is wave-guided in the light collection section 52A to travel in the +y direction and then reach the lower end surface 24, in the same manner as in the light collection section 52A.

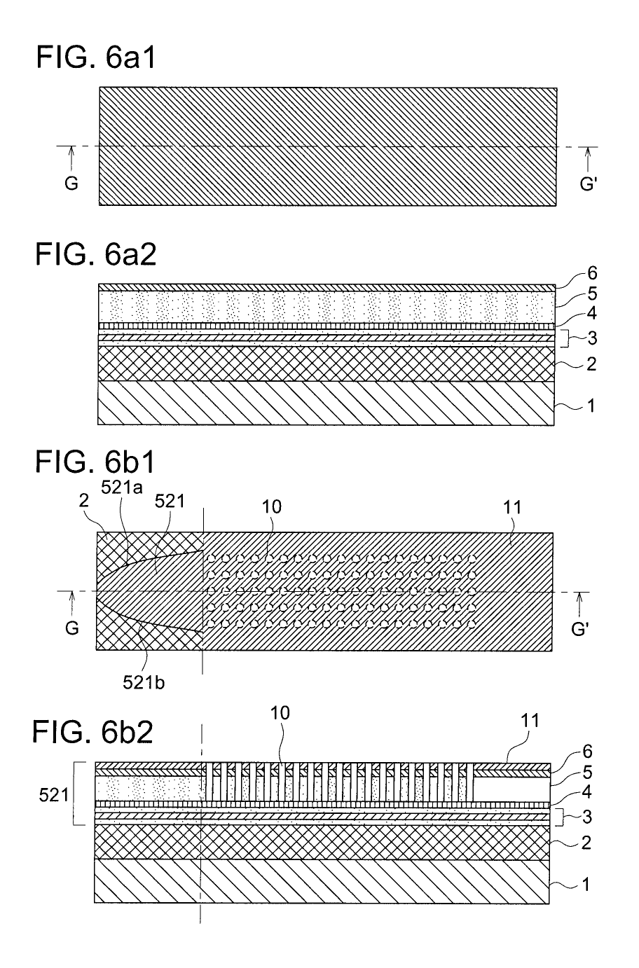

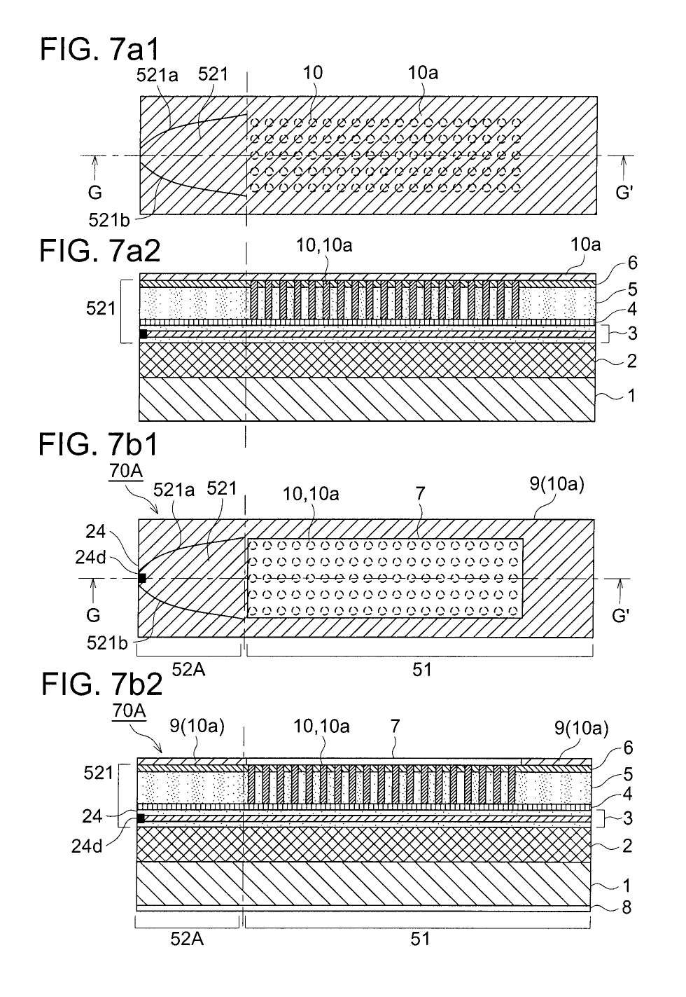

Next, a production method of a light spot forming element 70A according to the present embodiments will be described. FIG. 6 and FIG. 7 are cross-sectional step charts showing the production method of the light spot forming element 70A, and FIGS. 6A and 6B and FIGS. 7A and 7B show individual steps.

Specifically, there will be described a production method of an oscillation section 51 having a photonic crystal structure of a 980 nm band employing InGaAs for the active layer on a GaAs substrate and a light collection section 52A. Incidentally, even in a material type of another wavelength band such as, for example, an InGaAsP-based material on an InP substrate or an InGaN-based or AlGaN-based material on a GaN substrate, the same production method is employed.

As shown in FIGS. 6A1 and 6A2, over the entire surface of a substrate 1 formed of n-type GaAs, a semiconductor laser structure is formed. FIG. 6A1 is a top view of a formed semiconductor laser structure body and FIG. 6A2 is a G-G′ arrow cross-sectional view of FIG. 6A1.

Initially, on a substrate 1 formed of n-type GaAs, semiconductor laser structures are sequentially grown via a metal organic vapor phase epitaxy (MOVPE) method or a molecular beam epitaxy (MBE) method.

Specifically, on a substrate 1, a second clad layer 2 (thickness: 2.0 μm) formed of n-type Al_{0.4}Ga_{0.6}As, an additive-free InGaAs/GaAs quantum-well active layer 3, a carrier stop layer 4 (thickness: 40 nm) formed of p-type Al_{0.6}Ga_{0.4}As, a first clad layer 5 (thickness: 0.5 μm) formed of p-type GaAs, and a contact layer 6 (thickness: 20 nm) formed of p+-type GaAs are sequentially formed in a layered manner.

The active layer 3 has a distorted quantum-well structure containing a 3-period InGaAs well layer (thickness: 8 nm), GaAs barrier layer (thickness: 20 nm), and separate confinement heterostructure layer (SCH layer) (thickness: 20 nm), being designed so as for quantum-well emission wavelength to be 980 nm.

Subsequently, as an etching mask layer (not shown), SiO₂ (SiN or a metal (such as Ni, Cr, or Ti) is employable) is subjected to film formation on the contact layer 6 via plasma CVC, sputtering, or vapor deposition and then thereon, a resist layer (an electron beam resist or imprint material) is subjected to film formation by a method such as spin coating.

Thereafter, using electron beam lithography or a nanoimprint method, a two-dimensional photonic crystal structure pattern and a waveguide pattern whose outer circumference is parabolic are formed on the resist layer and then the patterns having been formed on the resist layer are transferred to an etching mask layer via dry etching such as RIE (reactive ion etching) or ICP (inductively coupled plasma).

Incidentally, when light of a wavelength of 980 nm is oscillated, the period of a two-dimensional photonic crystal structure pattern is allowed to be about 290 nm and the diameter of an opening pattern to form a concave portion 10 is allowed to be about 50-200 nm. Herein, the opening pattern needs only to fit into a desired shape of the concave portion 10, being possibly square, rectangular, or circular. In the present embodiments, to match the shape of the concave portion 10, a circular shape is employed.

Subsequently, as shown in FIGS. 6B1 and 6B2, the etching mask layer 11 having been subjected to pattern transfer is etched as a mask via dry etching such as ICP or RIE to form a core layer 521 whose outer circumferential outline is parabolic constituting concave portions 10 and a light collection section 52A. The region of the light collection section 52A needs to be etched more (more deeply) than the region of the oscillation section 51 by the depths of the carrier stop layer 4 and the active layer 3. A countermeasure therefor can be taken using a method in which the thickness of the etching mask layer 11 is provided with steps so that concave portions 10 of the oscillation section 51 are delayed behind the removal region of the light collection section 52A in etching or a method in which concave portions 10 are etched less than the light collection section 52A by use of the micro-loading effect in which etching rate is increased with increased opening area. Herein, FIGS. 6B1 and 6B2 show the state prior to removal of the etching mask layer 11, and in the light collection section 52A, on the outside of the sides 521a and 521b of the outer circumferential outline of the parabolic shape of the core section 521, the second clad layer 2 is exposed.

As etching gas, methane/hydrogen-based gas, chlorine-based gas, iodine-based gas, or bromine-based gas which is commonly used in dry etching of III-IV group semiconductors is employed.

In etching, the cross-section of a two-dimensional crystal structure may be shaped into a taper shape. Etching methods in this case are described below. As a first method, there is a method in which at the initial stage of etching, a hole of small diameter is formed as an etching mask pattern and then by use of receding of the mask resulting from the progress of etching, the diameter of the mask opening portion is allowed to gradually increase, whereby the diameters of the upper and lower portions of a concave portion 10 are allowed to differ.

As a second method, there is a method in which etching conditions so as for the side wall protection of a concave portion 10 which is being formed via etching to be enforced are set. Namely, etching conditions so that with etching, a protection film is deposited on the side wall to reduce the hole diameter are employed.

Herein, utilization of the nature that etching grade largely varies with the Al composition depending on the etching gas makes it possible to use a carrier stop layer 4 as the etching stop layer.

Subsequently, as shown in FIGS. 7A1 and 7A2, the etching mask layer 11 is removed with buffered hydrofluoric acid and thereafter a burying material 10a is buried in concave portions 10. FIG. 7A1 is a top view showing the state where a burying material 10a is provided on the contact layer 6 of the semiconductor laser oscillation section 51 and on the concave portions 10 and the second clad layer 2 of the light collection section 52A, and FIG. 7A2 is a G-G′ arrow cross-sectional view of FIG. 7A1.

The buring material 10a is a material such as SiO₂, SiN, SOG (spin on glass), polyimide, or BCB (benzocyclobutene) featuring transparency in the oscillation wavelength of a laser and electrical insulation properties and such a material needs to exhibit heat resistance capable of enduring heating in the electrode alloying step during electrode formation. As the burying method, usable is a chemical vapor deposition (CVD) method such as plasma CVD (Chemical Vapor Deposition) or LPCVD (Low Pressure Chemical Vapor Deposition), a sputtering method, or a spin coating method.

A burying material 10a is buried in the concave portions 10 and thereby the upper surface of the contact layer 6 is flattened to easily carry out electrode formation on the upper surface of the contact layer 6. Further, as in the present embodiments, the burying material 10a is preferably a material such as, e.g., SiO₂, exhibiting smaller refractive index than the core section 521, capable of being used as the protective layer. When a burying material 10a is buried in the concave portions 10, the parabola-shaped outer circumference and the upper surface of the light collection section 52A and the upper surface of the oscillation section 51 are covered with the burying material 10a at the same time. Thereby, a protective layer 9 having been formed in the light collection section 52A functions as the clad, also allowing the semiconductor laminated portion to be non-exposed to air in the same manner as the protective layer 9 formed in the oscillation section 51, whereby element degradation due to oxidation can hardly occur.

Then, as shown in FIGS. 7B1 and 7B2, via photolithography and etching, in the portion of the photonic crystal structure region of the burying material 10a, an opening is provided to expose the contact layer 6, and then in the opening, a first electrode 7 is formed. Then, at the bottom of the substrate 1, a second electrode 8 is formed.

Subsequently, at the ejection position of light on the lower end surface 24, a metallic plasmon antenna 24d to be described later is formed. For example, Cr serving as the mask material is vapor-deposited on the tip surface in the light ejection position of the light collection section 52A to form a mask having the reverse shape of the plasmon antenna 24d via EB (Electron Beam) irradiation. Thereafter, as a material of the plasmon antenna 24d, gold is vapor-deposited to remove the mask via liftoff. The plasmon antenna 24d may be formed on the tip surface in the light ejection position of the light collection section 52, being, however, preferably in the state of being buried in the tip surface of the light collection section 52A as shown in FIG. 7B. Burying in the light collection section 52A makes it possible that non-uniformity of the surface of the slider 30 opposite to the disk 102 is eliminated and then an ABS structure to float the slider 30 becomes easy to constitute. When such a plasmon antenna 24d is buried in the light collection section 52A, etching is carried out prior to gold deposition in the above to form a mask-shaped depression.

Via the above procedures, a light spot forming element 70A is competed. Herein, FIG. 7B1 is a top view of a completed light spot forming element 70A and FIG. 7B2 is a G-G′ arrow cross-sectional view of FIG. 7B1.

When a light spot forming element 70A is provided in the side of the slider 30 as shown in FIG. 2, a portion to eject a light spot of the light spot forming element 70A is preferably arranged in the vicinity of the magnetic recording section 35. Therefor, the first electrode 7 side of the light spot forming element 70A is preferably fixed toward the slider 30. For such fixing, it is possible that, for example, a film to ensure the insulating performance of the first electrode 7 of the light spot forming element 70A and also to protect the electrode is further provided so as to cover the entire surface of the first electrode 7 of the light spot forming element 70A.

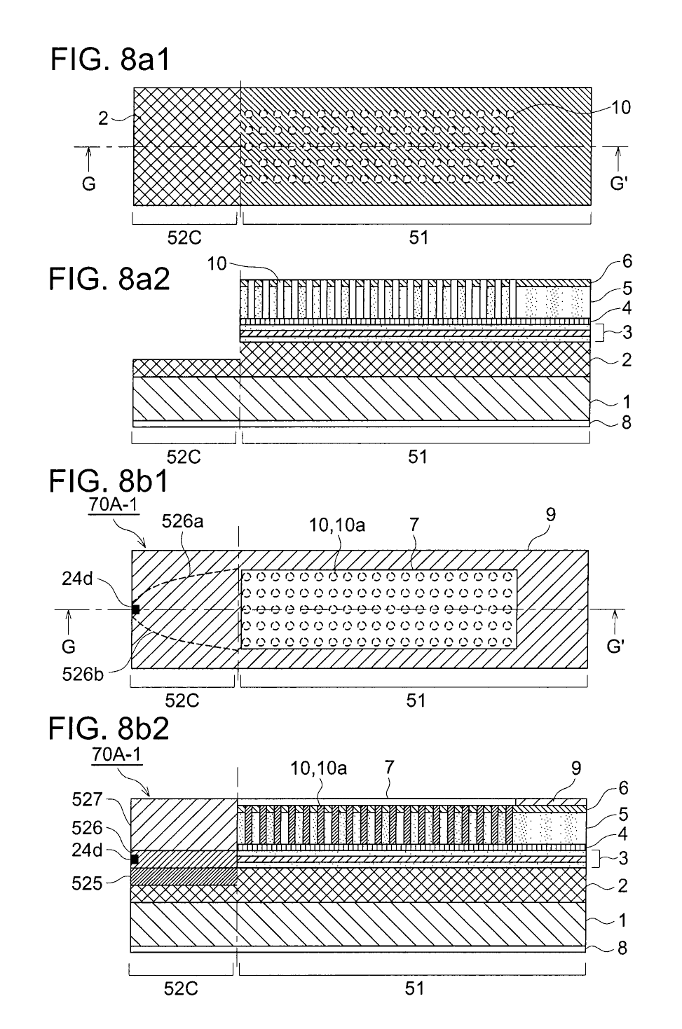

In the above light collection section 52A, the semiconductor laminated portion above from the active layer 3 including the active layer 3 is used as the core section 521 constituting the waveguide. As an example of a light collection section 52 employing no semiconductor laminated portion, a light spot forming element 70A-1 is shown in FIG. 8.

In the light spot forming element 70A-1, as the constitution of the light collection section 52, a light collection section 52C employing no semiconductor laminated portion is formed. FIGS. 8A1 and 8B1 are top views of the light spot forming element 70A-1 and FIGS. 8A2 and 8B2 are G-G′ arrow cross-sectional views of FIGS. 8A1 and 8B1, respectively. A semiconductor laser structure body formed on the substrate 1 and an oscillation section 51 in the light spot forming element 70A-1 are the same as in the light spot forming element 70A and therefore description thereof will be omitted.

When concave portions 10 are formed via etching having been described with reference to above FIGS. 6B1 and 6B2, part of the second clad layer 2 to become the place where the constitutional portion of the light collection section 52C is formed, the active layer 3, the carrier stop layer 4, the first clad layer 5, and the contact layer 6 are removed. The state where this removal has been carried out is shown in FIGS. 8A1 and 8A2.

Then, as shown FIGS. 8B1 and 8B2, a lower clad layer 525, a core layer 526, and an upper clad layer 527 are provided. In the position where a light collection section 52C is formed, on the second clad layer 2 having remained after etching, a lower clad layer 525 constituting a waveguide with a thickness such that the upper surface approximately corresponds to the lower surface of the active layer 3 is formed. Then, a material to be formed as a core layer having almost the same thickness as the active layer 3 is laminated and thereafter via photolithography and etching, the outer circumferential outline is formed into a parabolic shape to form a core layer 526. In FIG. 8B1, 2 sides in which the outer circumferential outline is parabolic are shown as sides 526a and 526b.

Subsequently, an upper clad layer 527 is laminated so as to further cover the lower clad layer 525 provided with the core layer 526 whose outer circumferential outline has been formed into a parabolic shape.

The refractive index of the core layer 526 is preferably about 1.45-4.0, and the refractive indexes of the lower clad layer 525 and the upper clad layer 527 are smaller than that of the core layer 526, preferably about 1.0-2.0 with no limitation to these ranges.

The core layer 526 is formed with Ta₂O₅, TiO₂, or ZnSe and the thickness thereof is preferably about 20 nm-500 nm with no limitation to this range. Further, the lower clad layer 525 and the upper clad layer 527 are formed. with SiO₂ or Al₂O₃ and the thicknesses thereof are preferably about 200 nm-2000 nm with no limitation to this range.

As the forming method of the core layer 526, the lower clad layer 525, and the upper clad layer 527, plasma CVD, sputtering, and vapor deposition are listed.

When an upper clad layer 527 is formed, a material to form the upper clad layer 527 may be buried in concave portions 10 in common with a burying material 10a or may cover the contact layer 6 so as to be formed as a protective layer 9. Then, in the same manner as in the light spot forming element 70A, a first electrode 7, a second electrode 8, and a plasmon antenna 24d are provided to complete a light spot forming element 70A-1.

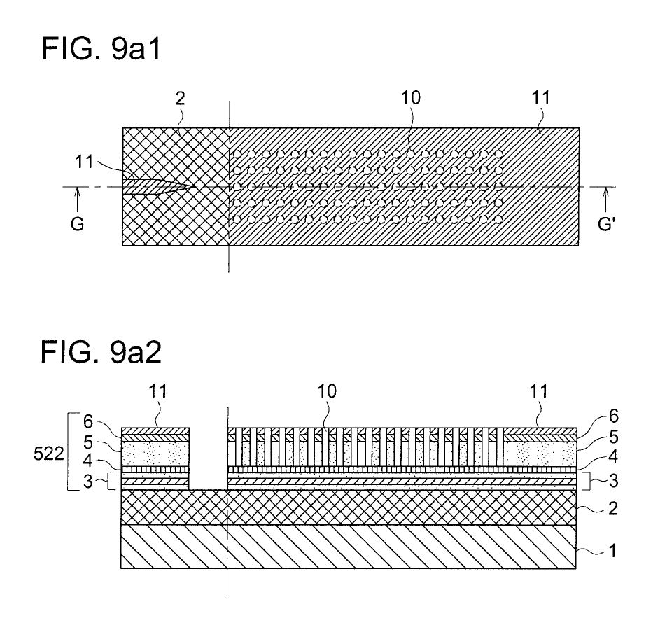

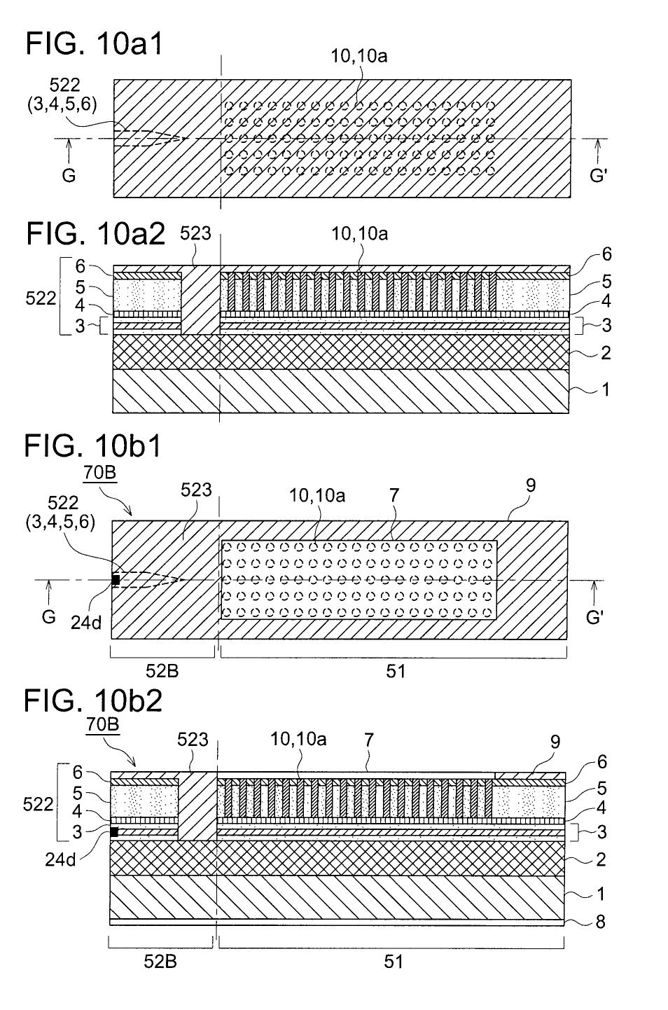

Next, a production method of a light spot forming element 70B according to the present embodiments will now be described. FIG. 9 and FIG. 10 are cross-sectional step charts showing the production process of the light spot forming element 70B, and FIGS. 9A and FIGS. 10A and 10B are individual step charts. A semiconductor laser structure body formed on the substrate 1 and an oscillation section 51 in the light spot forming element 70B are the same as in the light spot forming element 70A and therefore description thereof will be omitted.

When concave portions 10 are formed via etching having been described with reference to above FIGS. 6B1 and 6B2, as shown in FIG. 9, in the region to become the place where a light collection section 52B is formed, portions of the active layer 3, the carrier stop layer 4, the first clad layer 5, and the contact layer 6 are allowed to remain as an island and other portions are removed. A semiconductor laminated portion having remained as this island is allowed to serve as the core section 522 of the light collection section 52B. FIG. 9A1 is a top view showing the state where in the substrate 1 in which the oscillation section 51 is formed, on the second clad layer 2 as the place where the light collection section 52B is formed, a core section 522 is formed as an island and FIG. 9A2 is a G-G′ arrow cross-sectional view of FIG. 9A1.

Then, as shown in FIGS. 10A1 and 10A2, to cover the entire island-shaped core section 522, a clad section 523 is formed. A material to form the clad layer 523 may be buried in concave portions 10 in common with a burying material 10a or may cover the contact layer 6 of the oscillation section 51 as a protective layer 9. FIG. 10A1 is a top view showing the state where in the substrate 1 in which the oscillation section 51 is formed, a clad section 523 is formed so as to cover the core section 522 of the light collection section 52B and FIG. 10A2 is a G-G′ arrow cross-sectional view of FIG. 10A1.

Subsequently, as shown in FIGS. 10B1 and 10B2, in the same manner as in the light spot forming element 70A, a first electrode 7, a second electrode 8, and a plasmon antenna 24d are provided to complete a light spot forming element 70B. FIG. 10B1 is a top view of a completed light spot forming element 70B and FIG. 10B2 is a G-G′ arrow cross-sectional view of FIG. 10B1.

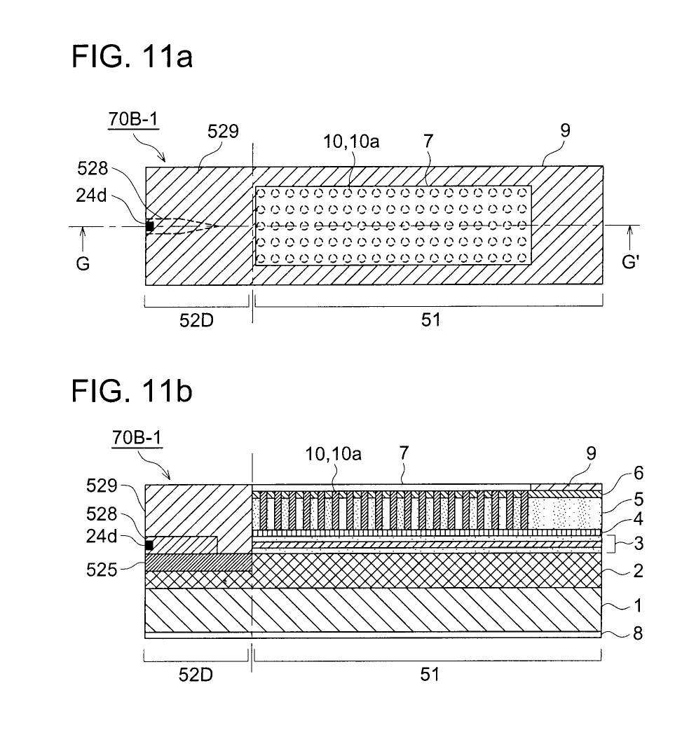

In the above light collection section 52B, the semiconductor laminated portion above from the active layer 3 including the active layer 3 is used as the core section 522 constituting the waveguide. As an example of a light collection section 52 employing no semiconductor laminated portion, a light spot forming element 70B-1 is shown in FIG. 11.

In the light spot forming element 70B-1, as the constitution of the light collection section 52, a light collection section 52D employing no semiconductor laminated portion is formed. FIG. 11A is a top view of a light spot forming element 70B-1 and FIG. 11B is a G-G′ arrow cross-sectional view of FIG. 11A. A semiconductor laser structure body formed on the substrate 1 and an oscillation section 51 in the light spot forming element 70B-1 are the same as in the light spot forming element 70A and therefore description thereof will be omitted.

When concave portions 10 are formed via etching having been described with reference to above FIG. 6, part of the second clad layer 2 to become the place where the constitutional portion of the light collection section 52D is formed, the active layer 3, the carrier stop layer 4, the first clad layer 5, and the contact layer 6 are removed. The removed state is the same as in FIGS. 8A1 and 8A2 and therefore description thereof will be omitted.

Then, as shown FIGS. 11A1 and 11A2, a lower clad layer 525, a core layer 528, and an upper clad layer 529 are provided. In the position where a light collection section 52D is formed, on the second clad layer 2 having remained after etching, a lower clad layer 525 constituting a waveguide with a thickness such that the upper surface approximately corresponds to the lower surface of the active layer 3 is formed. Then, a material to be formed as a core layer having almost the same thickness as the active layer 3 is laminated and thereafter via photolithography and etching, an island shape extending in the y direction in which the oscillation section 51 side is sharp-pointed and the opposite side is flat in the same face as the lower end surface 24 is formed as a core layer 528. Subsequently, an upper clad layer 529 is laminated so as to cover the lower clad layer 525 provided with the core layer 528 having been formed into an island shape.

The refractive index of the core layer 528 is preferably about 1.45-4.0, and the refractive indexes of the lower clad layer 525 and the upper clad layer 529 are smaller than that of the core layer 528, preferably about 1.0-2.0 with no limitation to these ranges.

The core layer 528 is formed with Ta₂O₅, TiO₂, or ZnSe and the thickness thereof is preferably about 20 nm-500 nm with no limitation to this range. Further, the lower clad layer 525 and the upper clad layer 529 are formed with SiO₂ or Al₂O₃ and the thicknesses thereof are preferably about 200 nm-2000 nm with no limitation to this range.

As the forming method of the core layer 528, the lower clad layer 525, and the upper clad layer 529, plasma CVD, sputtering, and vapor deposition are listed.

When an upper clad layer 529 is formed, a material to form the upper clad layer 529 may be buried in concave portions 10 in common with a burying material 10a, or may cover the contact layer 6 so as to be formed as a protective layer 9. Then, in the same manner as in the light spot forming element 70A, a first electrode 7, a second electrode 8, and a plasmon antenna 24d are provided to complete a light spot forming element 70B-1.

As having been described so far, both a light collection section 52 and a semiconductor laser oscillation section 51 can be integrated on a single substrate 1. Thereby, compared with the case where as a conventional light source, for example, a semiconductor laser and a light collection section such as a PSIM are fixed as a combination of individual components, easy handling is realized and the problem that the locational relationship between both shifts during operation can be avoided. Further, the oscillation section 51 can oscillate only light having a certain wavelength.

Therefore, the light spot forming element 70 according to the present invention is easy to handle and can efficiently form a stable light spot.

Further, in the light spot forming element 70 having been described above with respect to production, an oscillation section 51 and a light collection section 52 are produced on a substrate 1 via the same process as in the semiconductor process. Thereby, the arrangement accuracy of an integrated oscillation section 51 and light collection section 52 is remarkably increased compared with the conventional mechanical arrangement.

In the light spot forming element 70 having been described so far, in the case where an oscillation section 51 and a light collection section 52A have the same composition as in the light spot forming element 70A, no current is injected into the light collection section 52A, which thereby becomes an absorption region, resulting in a partial loss of light having been ejected from the laser. Therefor, to eliminate such an absorption loss via wavelength reduction of the band gap of the resonator region of the semiconductor laser oscillation section 51, quantum-well intermixing (QWI) is employable.

In the above description, as the material of the semiconductor laminated portion, examples employing III-V group semiconductors have been described. However, an organic dye laser using an organic light-emitting material is also employable. Further, as the drive method, other than the method by use of current injection having been described so far, a method via photoexcitation is employable.

### DESCRIPTION OF THE SYMBOLS

1: substrate

2: second clad layer

3: active layer

4: carrier stop layer

5: first clad layer

6: contrast layer

7: first electrode

8: second electrode

10: concave portion

10a: burying material

24: lower end surface

24d: plasmon antenna

30: slider

50: light

51: semiconductor laser oscillation section

52, 52A, 52B, 52C, and 52D: light collection sections

521 and 522: core sections

523: clad section

526 and 528: core layers

525: lower clad layer

527 and 529: upper clad layers

521a, 521b, 526a, and 526b: sides

70, 70A, 70A-1, 70B, and 70B-1: light spot forming elements

101: housing

102: disk

103: optical recording head

104: suspension

105: arm

100: optical recording device

Lp: length

Wm and Wp: widths

F: focus

C: axis

1-7. (canceled)

8. A light spot forming element comprising:
a laser oscillation section having a periodic refractive index distribution used as a laser resonator; and
a light collection section for introducing light emitted from the laser oscillation section and for forming a light spot by collecting the introduced light,
wherein the laser oscillation section and the light collection section are formed on a single substrate.

9. The light spot forming element described in claim 8, further comprising a plasmon antenna in a vicinity of a location where the light spot is formed to generate plasmon by irradiation of collected light and amplify the plasmon to be taken out as near-field light resulting in the light spot.

10. The light spot forming element described in claim 8, wherein the light collection section is a light waveguide having a core layer provided with 2 side surfaces defining substantially parabolic outlines and a tip portion having a light ejection surface, from which light is ejected, defined by end portions of the 2 side surfaces in a vicinity of a location where the light spot is formed; and light emitted from the laser oscillation section is introduced from a light introduction opening defined by end portions of the 2 side surfaces on an opposite side to the tip portion.

11. The light spot forming element, described in claim 8, wherein the light collection section comprises: a light waveguide having a core arranged along a light path from an end portion of the laser oscillation section to a location where the light spot is formed in which one end is located away from the end portion of the laser oscillation section, the other end is located at a location where the light spot is formed, and a cross-section area of the one end is smaller than a cross-section area of the other end; and a clad to bury a space from the end portion of the laser oscillation section to the location where the light spot is formed so as to wrap the core, and a refractive index of a material of the clad is smaller than a refractive index of a material of the core.

12. The light spot forming element, described in claim 8, wherein the periodic refractive index distribution has a structure where refractive index is periodically changed in directions at right angles to each other.

13. An optical recording head to carry out information recording on a recording medium using light, comprising: a slider which moves relatively to the recording medium; and the light spot forming element of claim 8.

14. An optical recording device comprising: the optical recording head described in claim 13 provided with a magnetic recording section; and the recording medium on which information is recorded by the optical recording head.
